(19) United States
(12) Patent Application Publication
(10) Pub. No.: US 2019/0318065 A1
(43) Pub. Date: Oct. 17, 2019

(54) DELIVERY AND MONITORING USE OF LICENSED CONTENT IN AUGMENTED REALITY

(71) Applicant: IAS Machine, LLC, Newcastle, WA (US)

(72) Inventors: Roger Brent, Seattle, WA (US); John Max Kellum, Seattle, WA (US); Jamie Douglas Tremaine, Toronto (CA)

(21) Appl. No.: 16/382,075

(22) Filed: Apr. 11, 2019

Related U.S. Application Data
(60) Provisional application No. 62/656,261, filed on Apr. 11, 2018.

(51) Int. Cl. G06F 21/10; G06F 21/12; G06F 3/01; G06T 19/00

(52) U.S. Cl. CPC G06F 21/105; G06F 21/121; G06T 19/006; G06F 3/013; G06F 3/017

(57) ABSTRACT

A method for monitoring and delivering licensed content involves displaying an interactive guided process with one or more augmented reality/mixed reality (AR/MR)) layers through an AR/MR device, detecting user/operator interactions during the interactive guided process in the AR/MR layer as a content request and storing the user/operator interactions in a user/operator interaction log, validating the content request and releasing requested content to the AR/MR device, displaying the requested content through the AR/MR layer, recording user/operator content interactions with the requested content in a content interaction log, normalizing the user/operator content interactions to the previous user/operator content interactions and generating a user/operator engagement metrics, and communicating the user/operator engagement metrics and previous user/operator interactions to a content management engine.

### CROSS-REFERENCE TO RELATED APPLICATIONS

This application claims the benefit of U.S. provisional patent application Ser. No. 62/656,261, filed on Apr. 11, 2018, the contents of which are incorporated herein by reference in their entirety.

### BACKGROUND

Augmented reality/mixed reality (AR/MR)) devices have the ability to display and run a variety of content of different types to users and operators based on their requests. Content can include procedural guidance, from open-loop display of information as to how to perform a procedure, to closed-loop interactive guidance that responds to and affects actions of the operator, and some types of content presented to the user/operator can be customized in real time. In some instances, the requested content requires a license in order to be displayed and run. Examples include material displayed visually, such as copyrighted material displayed in writing and movies and licensed interactive procedural content. Examples also include copyrighted material that is read out loud, songs, and music.

In laboratory work and related procedural work, content such as journal articles, protocols, or operator instructions may be presented or offered to, or displayed and run by, users of the AR/MR device. Some of this content may require a license before it can be presented or run. For content providers and owners, there is a need for the ability to monitor use of the licensed content—for example to collect royalties, determine what subscription content is most popular, and to gain information about customer engagement. For the organizations (such as universities and corporations that access licensed content), there is a need for the ability to determine which pieces of content are actually being utilized, for example to manage content libraries, payments, and subscriptions.

Further, some content for AR/MR devices may be difficult to use or engage with, which may lead to limited use of or engagement with the content or less reliable performance of procedures by operators. Information about user/operator engagement will be of use creators, licensers, and purchasers of licensed content. Therefore, a need exists to determine user/operator engagement with licensed content presented or run on AR/MR devices.

### BRIEF SUMMARY

This disclosure relates to a method and computing apparatus for monitoring and delivering licensed content through an augmented reality/mixed reality (AR/MR)) device. The method comprises displaying an interactive guided process comprising at least one AR/MR layer through an AR/MR device. The method further comprises detecting user/operator interactions (e.g., content requests) during the interactive guided process in the AR/MR layer as a content request and storing the user/operator interactions in a user/operator interaction log through operation of an AR/MR controller. The method further comprises validating the content request and releasing requested content to the AR/MR device through operation of a content license authenticator and displaying the requested content through the AR/MR layer. If the user does not have a valid license to access the requested content, the user is notified, and the requested content is not released. The method further comprises recording user/operator content interactions with the requested content in a content interaction log comprising previous user/operator content interactions with previous requested content. The method further comprises normalizing (i.e., comparing) these user/operator content interactions to previous user/operator content interactions and generating user/operator engagement metrics for the requested content through operation of an analytics engine. Finally, the method further comprises communicating the user/operator engagement metrics and previous user/operator interactions to a content management engine.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system 100 in accordance with one embodiment.

FIG. 2 illustrates a method 200 in accordance with one embodiment.

FIG. 3 illustrates a content management engine 300 in accordance with one embodiment.

FIG. 4 illustrates an AR/MR controller 400 in accordance with one embodiment.

FIG. 5 illustrates an analytics engine 500 in accordance with one embodiment.

FIG. 6 illustrates an embodiment of a digital apparatus 600 to implement components and process steps of the system described herein.

### DETAILED DESCRIPTION

“AR/MR layer” refers to an augmented reality layer of a platform that includes several layers, such as an operating system layer, an application layer, a user layer, and a device layer. For example, an augmented reality layer may contain the logic to run an AR device on a particular application.

“Comparator” refers to a logic element that compares two or more inputs to produce one or more outputs that reflects similarity or difference of the inputs. An example of a hardware Comparator is an operational amplifier that outputs a signal indicating whether one input is greater, less than, or about equal to the other. An example software or firmware Comparator is: if (input1==input2) output=val1; else if (input1>input2) output=val2; else output=val3; Many other examples of comparators will be evident to those of skill in the art, without undo experimentation.

“Controller” refers to logic, a collection of logic, or a circuit that coordinates and controls the operation of one or more input/output devices and synchronizes the operation of such devices with the operation of the system as a whole. For example, the Controller may operate as a component or a set of virtual storage processes that schedules or manages shared resources. For example, IF (Controller.logic {device1|device2|device3} {get.data( ), process.data( ), store.data( )}), −device1 get.data(input1)->data.input1; −device2 process.data(data.input1)->formatted.data1->−device3 store.data(formatted.data1).

“Engine” refers to logic or collection of logic modules working together to perform fixed operations on a set of inputs to generate a defined output. For example, IF (Engine.logic {get.data( ), process.data( ), store.data( ),} get.data(input1)->data.input1; process.data(data.input1)->formatted.data1->store.data(formatted.data1). A characteristic of some logic engines is the use of metadata that provides models of the real data that the Engine processes. Logic modules pass data to the Engine, and the Engine uses its metadata models to transform the data into a different state.

“Augmented reality” refers to a live, direct or indirect view of a physical, real-world environment whose elements are augmented (or supplemented) by computer-generated sensory input such as sound, video, graphics or GPS data. Augmented reality (AR) is essentially synonymous with mixed reality (MR) in a layer, controller, or device. In this disclosure, the term AR includes the combination of (AR/MR) in all combinations.

“Mixed reality” refers to essentially augmented reality (see above).

“Procedural content” refers to any licensed content that requires or encourages user interaction.

“Licensed content” refers to any content that requires a valid license to display and/or run, and may include, but is not limited to, procedural content and/or non-procedural content.

“Non-procedural content” refers to any licensed content, other than procedural content, and may include but is not limited to books, movies, and magazines. A user may have minimal interaction with non-procedural content, such as requesting the content and actions related to how the content is displayed (e.g., font size, color, location on screen, etc.).

A method for monitoring and delivering licensed content may verify user permissions to access licensed content through an AR/MR device. The method may record how much and for how long content is displayed and interacted with utilizing the AR/MR device, similar to how “page views” or “Nielsen” or “Arbitron” statistics provide metrics for consumption of television and radio programming. Due to the capabilities provided by AR/MR devices, the method may track the user's gaze (i.e., eye movement, position, and duration) and other user/operator physical indicators, such as pupil size, vocalizations, or other indices of positive and negative response, to measure interactions with the content. The method may track the user's gaze to determine whether the user is paying attention to the part of their field of view within the AR/MR device in which the particular content is displayed. Gaze information may, for example, allow content providers to detect when particular users/operators refer to specific pieces of content more often, or where a certain class of users/operators (such as novices) get stuck with more difficult passages of text, and might benefit from being provided additional information. For purposes of this disclosure a user may also be an operator and an operator may be a user. In an embodiment, either the user or the operator has direct permission to use the content. The user or operator with direct permission may grant the other permission to use/operate the content if the other does not have direct permission.

In the context of a university, corporate, or organizational work environment, the users/operators of AR/MR devices may have access to their organization's digital library via a proxy server for which they are pre-authenticated. This access may allow them to interact with the requested content through the AR/MR devices. The method additionally may allow for content creators, owners, purveyors, distributors, or publishers to know which items of their content are used (consumed) by members of an organization that subscribes to that content. For example, a scientific publisher may be able to know who within an organization subscribes to and interacts with the publisher's journals.

The method may utilize the data on how much time and attention users/operators spend with each piece of content (e.g., journal article) to select among content to present to users/operators. For instance, the data may suggest that certain pieces of content from some content publishers/content creators are more frequently interacted with. This may allow content publishers/content creators as well as information managers (e.g., university librarians) to learn what information resources are being used.

A method for monitoring and delivering licensed content may involve displaying an interactive guided process comprising an AR/MR layer through an AR/MR device, detecting user/operator interactions during the interactive guided process in the AR/MR layer as content requests and storing the user/operator interactions in a user/operator interaction log through operation of an AR/MR controller, validating the content requests and releasing requested content to the AR/MR device through operation of a content license authenticator, displaying requested content through the AR/MR layer, recording user/operator content interactions with the requested content in a content interaction log comprising previous user/operator content interactions with previous requested content, analyzing the user/operator content interactions with respect to the previous user/operator content interactions, generating user/operator engagement metrics for the requested content through operation of an analytics engine, and communicating the user/operator engagement metrics and previous user/operator interactions to a content management engine.

In an embodiment, if any content was not delivered because it was not currently licensed, the user/operator may be made aware of the need to license such content in both real time or saved for review. In other words, if a user does not have rights to particular content, that user needs to get notice of this lack of rights.

In some embodiments, the requested content comprises procedural content that requires user interaction through a procedural interactive guided process and displaying the requested content through the at least one AR layer may further include running the procedural content that requires user interaction through the procedural interactive guided process. Additionally, detecting the user interactions may further include detecting the user content interactions during execution of a closed-loop process during the running of the procedural content that requires user interaction through the procedural interactive guided process.

In some configurations, the AR/MR controller may be configured to generate a graphical user interface (GUI) through which a user/operator may interact with the interactive guided process. The AR/MR controller may also detect a sequence of events during the interactive guided process as a user interaction.

In some configurations, recording the user/operator content interactions may involve detecting user/operator physical indicators, such as eye position, pupil size, vocalizations, etc., relative to the requested content as user/operator content interactions, and recording the duration of the user/operator content interactions with the requested content.

In some configurations, the content management engine may communicate a content license control to the content license authenticator, following comparison of the user/operator engagement metrics to a content engagement threshold. The content management engine may also communicate the user/operator engagement metrics and the previous user/operator interactions to content creators.

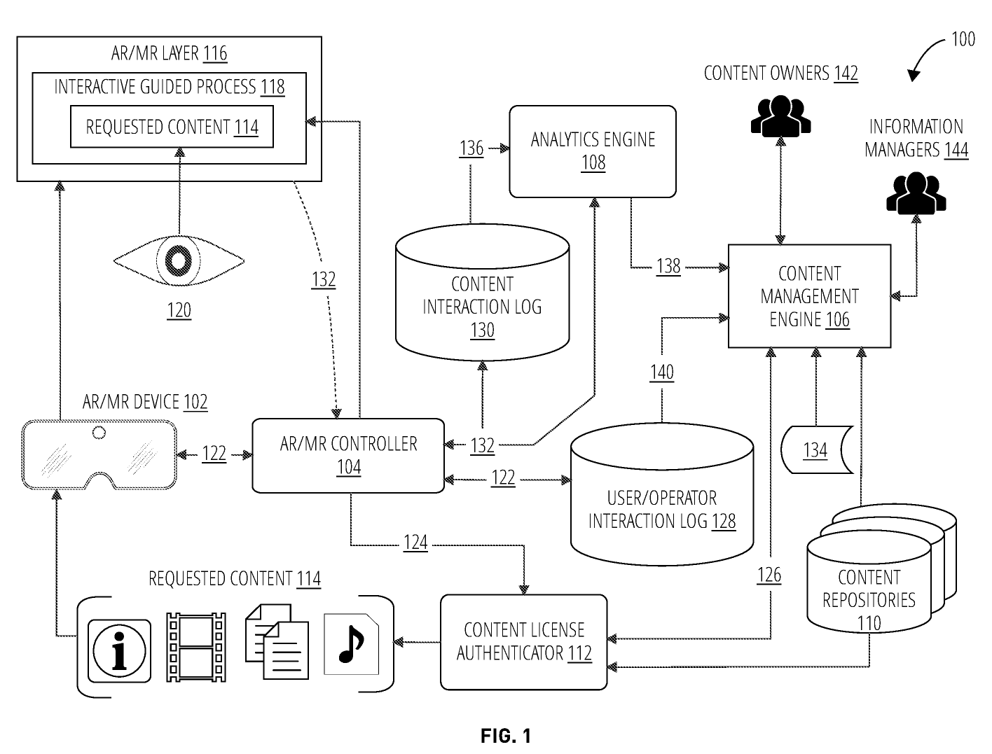

Referencing FIG. 1, a system 100 includes an AR/MR device 102, a content license authenticator 112, an analytics engine 108, and a content management engine 106. The AR/MR device 102 may include a camera to capture visual information of the surrounding environment, a display to generate an AR/MR layer 116 that displays an interactive guided process 118 overlaid on top of visualization of the surrounding environment, and an AR/MR controller 104 to control correlation of visualized environmental objects to visual content presented in the interactive guided process 118. The interactive guided process 118 may additionally provide non-visual information to the user in the form of a vibration feedback system or audio cues.

In some embodiments, the AR/MR device 102 may be worn by a user/operator with a display positioned in front of their eyes showing the AR/MR layer 116. The AR/MR device 102 may include sensors to track user/operator physical indicators 120 (gaze, pupil size, vocalizations, etc.) and correlate the user/operator physical indicators 120 to an interaction within the interactive guided process 118. These sensors, as well as other input and output devices, may be integrated into the display and worn on the head, or may be distributed to wrist-wear, contact lenses, or other devices worn or held by the user/operator.

The interactive guided process 118 is an interactive layer of content that may present information, instructions, visual cues, and notifications correlated to interactions in the physical environment and/or the field of view of an AR/MR device's camera. The user may also interact with the interactive guided process 118 through various input controls (e.g. hardware buttons, voice commands, eye movement tracking, user head position, etc.) that are detected using an AR/MR controller 104.

The AR/MR controller 104 may detect user/operator interactions 122 with the AR/MR device 102, such as voice commands, hardware button inputs, eye movement, etc., to control what is displayed in the interactive guided process 118 of the AR/MR layer 116. The AR/MR controller 104 may detect a sequence of events presented in the interactive guided process 118 as a type of user/operator interaction. For example, as part of a closed-loop process of procedural guidance, user/operator completion of or progression through one stage of the interactive guided process 118 may trigger the next portion of the interactive guided process 118 to be presented. The AR/MR controller 104 may communicate the user/operator interactions 122 to a user/operator interaction log 128 for tracking previous user/operator interactions 140.

Data from the user/operator interaction log 128 may be used to adjust the AR/MR interactions in real time. This data may also be sent to content creators, content owners, content publishers, content distributors, and information managers. Data in the user/operator interaction log 128 may be used to tailor content customization for use in new protocols going forward. This may allow content creators, content publishers, etc. to provide content spanning multiple protocols, and to optimize content for presentation through specific protocols.

Records of user/operator movements, vocalizations, annotations, and other detailed interactions may be stored in the user/operator interaction log 128. These may then be used in quality control, user grading, and content or help function improvement. User/operator mistakes may indicate an area of content where help material may be offered, or more detailed explanations may be incorporated. Such support content may be incorporated as annotations that are then presented to a user/operator who has demonstrated a need for additional help through mistakes or by a a longer than average engagement time. Over time, such annotations may be reduced for a user/operator that demonstrates a growing familiarity with the content (e.g., as fewer mistakes are made, content is moved through more rapidly).

The AR/MR controller 104 is a logic unit or combination of logic units that control operations of the AR/MR device 102 in response to detecting user/operator interactions 122 and user/operator content interactions 132. The AR/MR controller 104 may detect the user/operator physical indicators 120 at a particular location in the interactive guided process 118 as user/operator interactions 122 to generate a content request 124. Certain types of content presented through the interactive guided process 118 may contain dynamic information and/or require a content license to be displayed to a user. To display licensed content, the AR/MR controller 104 may communicate the content request 124 to a content license authenticator 112.

The content license authenticator 112 is a logic unit that verifies if an AR/MR device 102 is eligible to receive requested content 114 for a content request 124 through a content license agreement. The AR/MR device 102 may be associated with a license or be linked to an organization or user profile that has a license agreement to view certain types of requested content 114. Requested content 114 may include publications such as scientific journals, video and audio files, instructional material from purchased educational resources, and other pieces of media intended for consumption and interaction.

Requested content may also include a class of content that may be categorized as “procedural guidance.” Procedural guidance may be “passive”, providing “open-loop” guidance. Open-loop guidance may include text boxes or arrow cues. Procedural guidance may also be “active,” including “closed-loop control.” In closed-loop control, the user/operator may be as much part of a controlled system as the AR/MR device, and the actions of the user/operator may affect the procedural guidance the AR/MR device delivers. Closed-loop control may range from a) the content requires affirmative input (e.g., confirmation) from the operator in order to proceed to a next step (as in, a checklist), to b) the content actively provides feedback that affects the movements of the operator, for example, by warning of overshoots or imminent errors, and thus providing full “closed-loop operator control.”

After the content license authenticator 112 verifies the content request 124, the content license authenticator 112 may release the requested content 114 from the content repositories 110 to the AR/MR device 102 to display the requested content 114 in the interactive guided process 118. In some configurations, the content license authenticator 112 may charge an organization or user profile for the requested content 114. In some configurations, the content license authenticator 112 may select a specific type or piece of content to deliver to the AR/MR device 102 for the content request 124 based on the associated content license agreement.

During the presentation of the requested content 114 in the interactive guided process 118, the AR/MR controller 104 may detect the user/operator physical indicators 120 relative to the requested content 114 as user/operator content interactions 132. The user/operator content interactions 132 may be specific types of interactions with displayed or executable content and may be utilized to gauge a user's/operator's engagement with the requested content 114.

In some instances, the requested content 114 may include instructions that the user/operator needs to follow, such as viewing a specific item in the physical environment within the field of view of the device. The AR/MR controller 104 may communicate the user/operator content interactions 132 to a content interaction log 130 to store the user/operator content interactions 132. The AR/MR controller 104 may also communicate the user/operator content interactions 132 to an analytics engine 108.

The analytics engine 108 is a collection of logic processes utilized to determine user/operator engagement metrics 138 for user/operator content interactions with a piece of requested content. The analytics engine 108 may receive the user/operator content interactions 132 from the AR/MR controller 104 and analyze the user/operator content interactions 132 against previous user/operator content interactions 136 stored in the content interaction log 130. The analytics engine may also compute or receive input that indicates physical measurements of the parameters of a user's/operator's engagement. Analyzed user/operator content interactions 132 may be distilled into a form of user/operator ability metadata or content effectiveness metadata. This metadata may include a user's/operator's past history, the most effective usage across various protocols, etc.

Analysis of the user/operator content interactions 132 may be provided to determine certain trends associated with a specific user/operator or group of users/operators or for a specific instance or model of AR/MR device. For instance, the requested content 114 may be textual information, and the user/operator content interactions 132 may include the duration of time that the user/operator physical indicators 120 indicate the user/operator spent viewing the requested content 114. (user/operator physical indicators may include user/operator eye position, pupil size, saccades, etc.) Analysis of the user/operator content interactions 132 with regard to previous user/operator content interactions 136 may account for the user's average reading speed. After the user/operator content interactions 132 have been analyzed, the analytics engine 108 may generate user/operator engagement metrics 138 and may communicate the user/operator engagement metrics 138 to a content management engine 106. The content management engine 106 may leverage data such as past user/operator history, as well as physical metrics, in real time, to improve the publication/presentation/execution of content.

The content management engine 106 may operate as logic to control communication about the user/operator engagement metrics 138 for a piece of requested content 114 to content creators, owners, publishers, distributors, etc. 142 and information managers 144, and to the analytics engine 108. The content management engine 106 may receive the user/operator engagement metrics 138 from the analytics engine 108 and compare the user/operator engagement metrics 138 to a content engagement threshold 134. If the user/operator engagement metrics 138 is below or above the content engagement threshold 134, the content management engine 106 may communicate a content license control 126 to the content license authenticator 112 to adjust the fee charged to the organization or user profile.

In some configurations, the content management engine 106 may communicate the content license control 126 to the content license authenticator 112 to change the type of content that is selected for the content request 124 based on the user/operator engagement metrics 138. The content management engine 106 may communicate the user/operator engagement metrics 138 and the previous user/operator interactions 140 to the content creators, owners, publishers, distributors, etc. 142 based on the content engagement threshold 134. For instance, if the requested content 114 is below a content engagement threshold 134 for many users/operators, the content management engine 106 may communicate the user/operator engagement metrics 138 and the previous user/operator interactions 140 to the content creators, owners, publishers, distributors, etc. 142 in order to allow the content creators, owners, publishers, distributors, etc. 142 to modify/improve the content. In some configurations, the content management engine 106 may store the user/operator engagement metrics 138 for a piece of content from various users/operators to be accessed by the content creators, owners, publishers, distributors, etc. 142 at their discretion to evaluate the impact of their content.

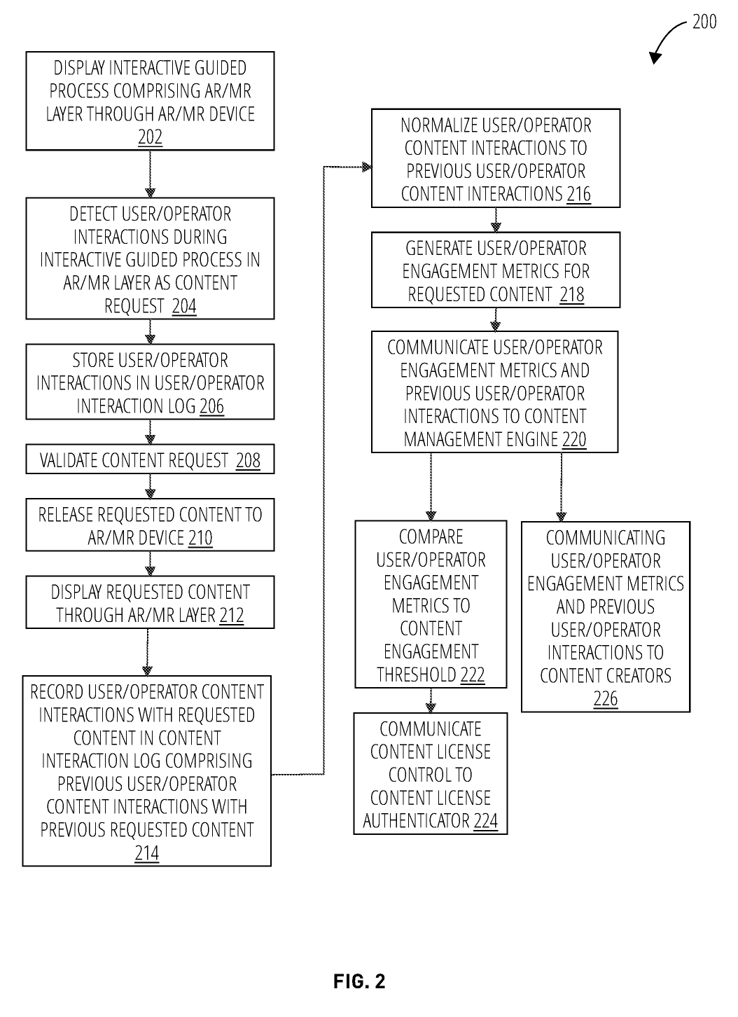

The system 100 may be operated in accordance with the process described in FIG. 2.

FIG. 2 illustrates a method 200 in accordance with one embodiment. The diagram of this embodiment shows the functions needed to carry out the method. The needed functions may be implemented in different arrangements of software, hardware, or a combination of these. This method 200 for monitoring and delivering licensed content involves displaying an interactive guided process comprising an AR/MR layer through an AR/MR device (block 202).

In block 204 and block 206, the method 200 operates an AR/MR controller to detect user/operator interactions during the interactive guided process in the AR/MR layer as a content request and stores the user/operator interactions in a user/operator interaction log.

In block 208 and block 210, the method 200 operates a content license authenticator to validate the content request and release requested content to the AR/MR device.

In block 212, the method 200 displays the requested content through the AR/MR layer of the AR/MR device.

In block 214, the method 200 records user/operator content interactions with the requested content in a content interaction log comprising previous user/operator content interactions with previous requested content.

In block 216 and block 218, the method 200 operates an analytics engine to normalize the user/operator content interactions to the previous user/operator content interactions and generate a user/operator engagement metrics for the requested content.

In block 220, the method 200 communicates the user/operator engagement metrics and previous user/operator interactions to a content management engine.

In block 222, the method 200 compares the user/operator engagement metrics to a content engagement threshold.

In block 224, the method 200 communicates a content license control to the content license authenticator.

In block 226, the method 200 communicates the user/operator engagement metrics and the previous user/operator interactions to content creators, owners, publishers, distributors, etc.

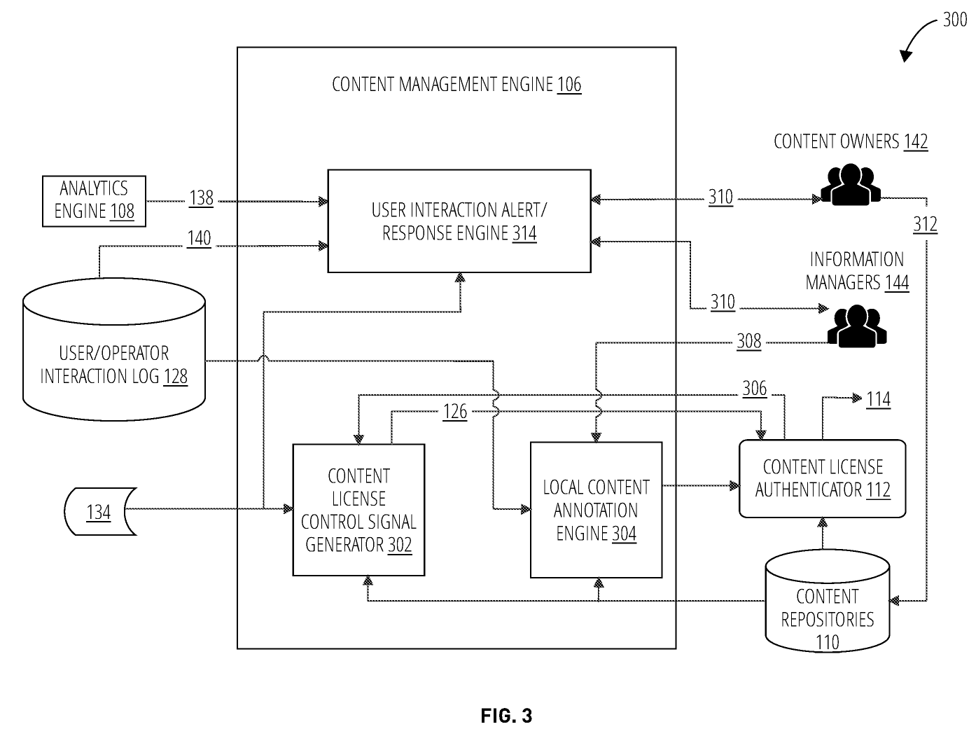

Referring to FIG. 3, a content management engine 300 is illustrated in accordance with one embodiment. The diagram of this embodiment shows mechanisms that may be used to carry out the content management tasks that support the method disclosed herein. These mechanisms may be implemented in different arrangements of software, hardware, or a combination of these. The content management engine 300 may comprise a content license control signal generator 302, a local content annotation engine 304, and a user interaction alert/response engine 314.

When a user/operator interacts with an AR/MR device in a manner that initiates a content request, an AR/MR controller associated with the AR/MR device may interface with a content license authenticator 112 to process the content request. The content license authenticator 112 may generate a content license request 306, which it transmits to the content license control signal generator 302 portion of the content management engine 300. The content license control signal generator 302 may have access to a lookup table in order to determine whether the AR/MR device or the user/operator employing the device is licensed to view the content in question. When a user/operator and/or AR/MR device are properly licensed for the content, the content license control signal generator 302 may return a content license control 126 signal indicating this to the content license authenticator 112. The content license authenticator 112 may then retrieve the requested content 114 from the content repositories 110 and pass the requested content 114 to the AR/MR controller for display/execution on the AR/MR device.

As a user/operator interacts with the requested content 114, they may wish to add their own annotations to the content they interact with. This may be accomplished by recording user/operator annotations within the user/operator interaction log 128. In such a case, the user/operator interaction log 128 may transmit a signal associated with these interactions to the local content annotation engine 304. The local content annotation engine 304 may further allow information managers 144 to monitor user/operator annotation interactions, as well as manage additional local annotations 308 they may wish to add to content they manage. As users/operators continue to interact with requested content 114, their own past annotations, local annotations 308 from the information managers 144, and in some embodiments, annotations from the content creators, owners, publishers, distributors, etc. 142, may be incorporated into the content they interact with on an institutionally or individually customized basis.

As users/operators interact with AR/MR content, their interactions may be recorded and analyzed as described earlier. User/operator engagement metrics 138 generated by the analytics engine 108 and previous user/operator interactions 140 stored in the user/operator interaction log 128 may be made available to the user interaction alert/response engine 314 within the content management engine 300. For example, should previous user/operator interactions 140 and present user/operator engagement metrics 138 indicate a negative interaction occurring consistently in response to a particular piece of content, content creators, owners, publishers, distributors, etc. 142 may be alerted. For example, if multiple users who have in the past interacted with a publisher's content along average metrics begin to exhibit a longer reading time, or exhibit pupil response, saccades, or vocalizations indicative of frustration, the content publisher may be alerted that their content is no longer eliciting a positive user engagement. In such a case, content creators, owners, publishers, distributors, etc. 142 may initiate additional queries to the user interaction alert/response engine 314 to learn more, and may create new/updated content 312 to correct the problem, which may then be stored in the content repositories 110.

Should user/operator engagement metrics 138 fail to meet a predetermined content engagement threshold 134, an alert may be sent to the content creators, owners, publishers, distributors, etc. 142 or information managers 144. For example, the content engagement threshold 134 may involve a limit of 10 article views per user/operator when interacting with a specific scientific journal to which the organization has access via subscription. Should users/operators consistently initiate more requests, information managers 144 may be alerted, and may take steps to upgrade the subscription. Alternately, if a minimum number of views is indicated by the content engagement threshold 134, and this threshold is not met, the information managers 144 may take steps to downgrade or discontinue the subscription. A mechanism may be provided for alerts/queries 310 to be transmitted to and from the content creators, owners, publishers, distributors, etc. 142 and the information managers 144 to allow for response to these conditions, or, in some embodiments, adjustments to the content engagement threshold 134.

The content engagement threshold 134 may also be provided as an input to the content license control signal generator 302. In this manner, if a content request causes an upper view limit to be exceeded, the content license control signal generator 302 may communicate that information to the content license authenticator 112. The user/operator request may then be rejected, with appropriate notification provided to the user/operator.

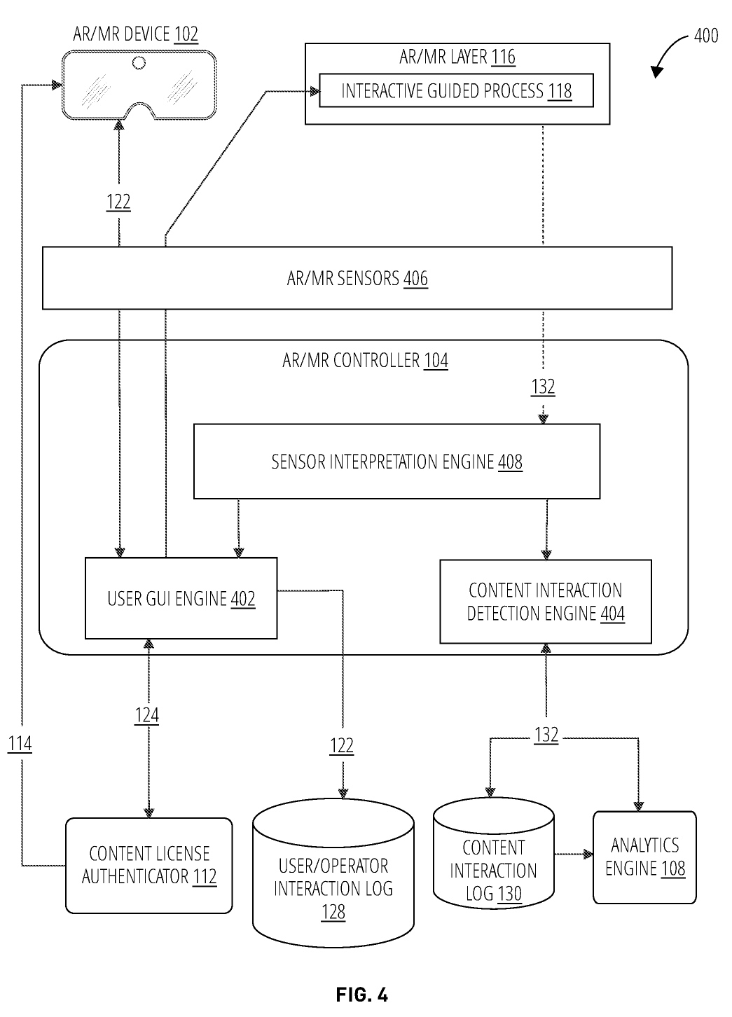

Referring to FIG. 4, an AR/MR controller 400 is illustrated in accordance with one embodiment. The diagram of this embodiment shows mechanisms that may be used to carry out the AM/MR tasks that support the method disclosed herein. These mechanisms may be implemented in different arrangements of software, hardware, or a combination of these. The AR/MR controller 400 may comprise a user GUI Engine 402, a content interaction detection Engine 404, and a sensor interpretation Engine 408.

When a user/operator initiates interaction with an AR/MR device, the user GUI Engine 402 within the AR/MR controller 400 may signal the AR/MR layer to begin an interactive guided process 118. Throughout the interactive guided process 118, the user GUI Engine 402 may continuously construct an interface though which the user/operator may receive information, as well as configure that interface to accept feedback from the user/operator as necessary. The user GUI Engine 402 may specifically be responsible for presenting procedural guidance to the user/operator and accepting user/operator response to procedural guidance implemented using a closed-loop process.

The user GUI Engine 402 may interact with the content license authenticator 112 to provide information about a content request 124, and may accept a return signal from the content license authenticator 112 if further user/operator interaction is needed. In some embodiments, all requested content 114 may be processed through the user GUI Engine 402, in order to provide a managed framework in which requested content 114 may be viewed or executed.

The user GUI Engine 402 may provide data on user/operator interactions 122 with the user/operator GUI it generates. These user/operator interactions 122 may be sent for storage to the user/operator interaction log 128. The user GUI Engine 402 may receive this data from the sensor interpretation Engine 408.

The sensor interpretation Engine 408 may be the portion of the AR/MR controller 400 responsible for processing input from the AR/MR sensors 406. AR/MR sensors 406 may include eye cameras, microphones, push buttons, or other sensors by which a user/operator response to content may be detected. The sensor interpretation Engine 408 may be configured to register and interpret user/operator content interactions 132 based on a user's/operator's eye position, gaze location, time duration spent at that location, pupil dilation, vocalizations, etc.

For example, a user/operator may be instructed to locate and gaze at a component of the GUI for a certain amount of time, or to blink some number of times while focused on that component, to select an option. A help function button may be displayed in a portion of the GUI, and the user/operator may be able to enter a help menu by focusing on the button and blinking twice. The sensor interpretation Engine 408 may send the coordinates of the user's/operator's gaze, corresponding to the button, as well as the information capturing two blinks, to the user GUI Engine 402. As a result, the user GUI Engine 402 may generate a display of the help menu to show the user.

The user/operator content interactions 132 processed by the sensor interpretation Engine 408 may also be interpreted and transmitted to a content interaction detection Engine 404. In this manner, user/operator content interactions 132 may be monitored and transmitted to a content interaction log 130 for storage. The user/operator content interactions 132 may also be transmitted to the analytics engine 108 for analysis.

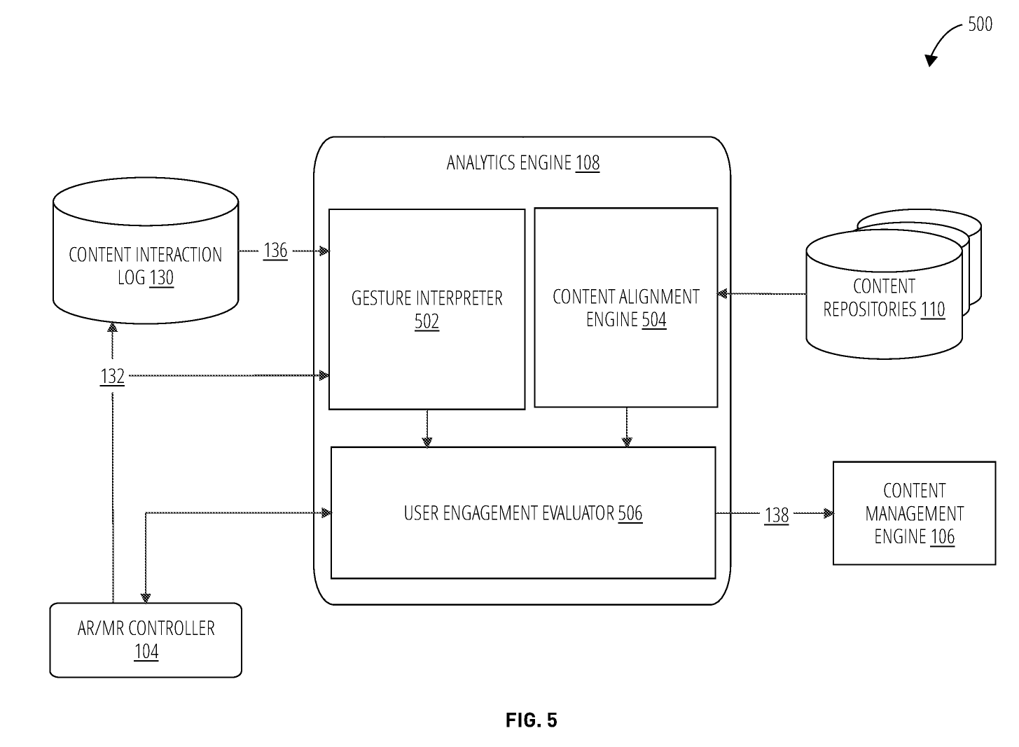

Referring to FIG. 5, an analytics engine 500 is illustrated in accordance with one embodiment. The diagram of this embodiment shows mechanisms that may be used to carry out the user engagement analytics tasks that support the method disclosed herein. These mechanisms may be implemented in different arrangements of software, hardware, or a combination of these. The analytics engine 500 may comprise a gesture interpreter 502, a content alignment engine 504, and a user engagement evaluator 506.

The gesture interpreter 502 may incorporate machine learning in order to inform an interpretation of the user/operator content interactions 132 it receives from the AR/MR controller 104 and the previous user/operator content interactions 136 from the content interaction log 130. This may include recognizing and assigning a positive or negative weight to optical gestures detected by the eye cameras, such as a rolling of eyes as a sign of frustration, or a dilation of the pupils as a sign of interest. Vocalizations such as sighs that are detected by microphones may also be so analyzed. The content alignment engine 504 may provide a means of referencing content stored in the content repositories 110, so that the interpreted gestures may be aligned with the content that elicited them.

The user engagement evaluator 506 may receive input regarding interpreted gestures from the gesture interpreter 502 and an indication of the content that elicited them from the content alignment engine 504. The user engagement evaluator 506 may also receive additional data from the AR/MR controller 104, which in some cases may require interpretation by the gesture interpreter 502 before evaluation. The user engagement evaluator 506 may evaluate the inputs it receives and generate user/operator engagement metrics 138, which it may transmit to the content management engine 106.

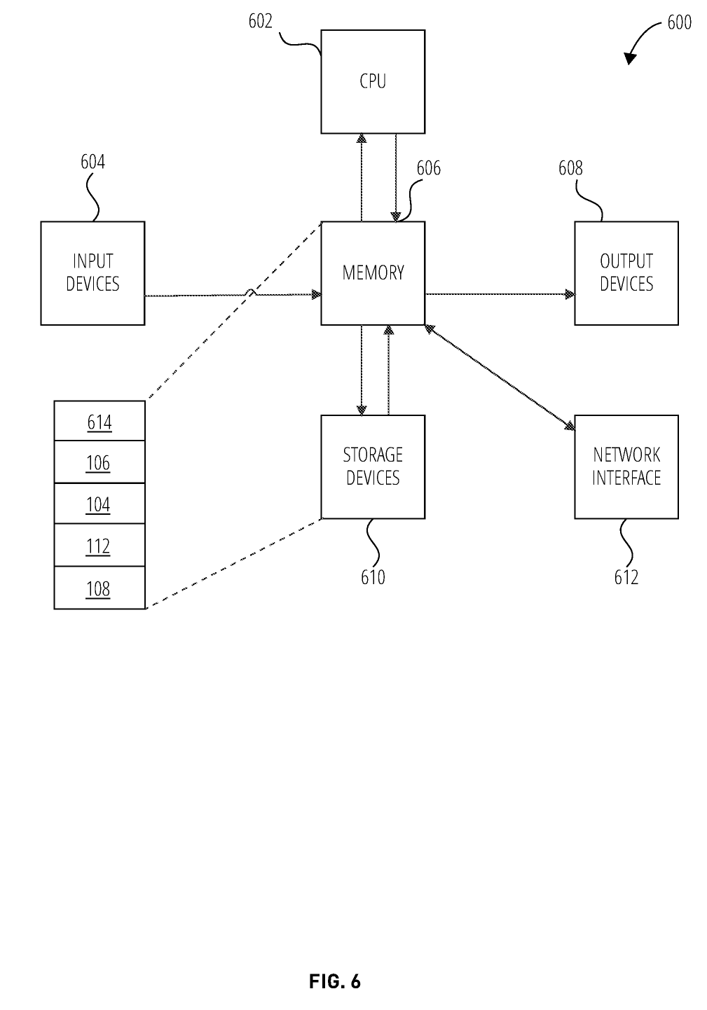

FIG. 6 illustrates an embodiment of a digital apparatus 600 to implement components and process steps of the system described herein.

Input devices 604 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 604 include keyboards which respond to touch or physical pressure from an object or proximity of an object to a surface, mice which respond to motion through space or across a plane, microphones which convert vibrations in the medium (typically air) into device signals, and scanners which convert optical patterns on two or three dimensional objects into device signals. The signals from the input devices 604 are provided via various machine signal conductors (e.g., busses or network interfaces) and circuits to memory 606.

The memory 606 is typically what is known as a first or second level memory device, providing for storage (via configuration of matter or states of matter) of signals received from the input devices 604, instructions and information for controlling operation of the CPU 602, and signals from storage devices 610.

The memory 606 and/or the storage devices 610 may store computer-executable instructions and thus forming logic 614 that when applied to and executed by the CPU 602 implement embodiments of the processes disclosed herein. The logic 614 may include log to operate the content management engine 106, the AR/MR controller 104, the content license authenticator 112, and the analytics engine 108.

Information stored in the memory 606 is typically directly accessible to the CPU 602 of the device. Signals input to the device cause the reconfiguration of the internal material/energy state of the memory 606, creating in essence a new machine configuration, influencing the behavior of the digital apparatus 600 by affecting the behavior of the CPU 602 with control signals (instructions) and data provided in conjunction with the control signals.

Second or third level storage devices 610 may provide a slower but higher capacity machine memory capability. Examples of storage devices 610 are hard disks, optical disks, large capacity flash memories or other non-volatile memory technologies, and magnetic memories.

The CPU 602 may cause the configuration of the memory 606 to be altered by signals in storage devices 610. In other words, the CPU 602 may cause data and instructions to be read from storage devices 610 in the memory 606 from which may then influence the operations of CPU 602 as instructions and data signals, and from which it may also be provided to the output devices 608. The CPU 602 may alter the content of the memory 606 by signaling to a machine interface of memory 606 to alter the internal configuration, and then converted signals to the storage devices 610 to alter its material internal configuration. In other words, data and instructions may be backed up from memory 606, which is often volatile, to storage devices 610, which are often non-volatile.

Output devices 608 are transducers which convert signals received from the memory 606 into physical phenomenon such as vibrations in the air, or patterns of light on a machine display, or vibrations (i.e., haptic devices) or patterns of ink or other materials (i.e., printers and 3-D printers).

The network interface 612 receives signals from the memory 606 and converts them into electrical, optical, or wireless signals to other machines, typically via a machine network. The network interface 612 also receives signals from the machine network and converts them into electrical, optical, or wireless signals to the memory 606.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Programmable device” in this context refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

Those having skill in the art will appreciate that there are various logic implementations by which processes and/or systems described herein can be effected (e.g., hardware, software, or firmware), and that the preferred vehicle will vary with the context in which the processes are deployed. In an exemplary embodiment, the logic implementations include various ways the system can handle delivery and monitoring use of licensed content in AR. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

The foregoing detailed description has set forth various embodiments of the devices or processes via the use of block diagrams, flowcharts, or examples. Insofar as such block diagrams, flowcharts, or examples contain one or more functions or operations, it will be understood as notorious by those within the art that each function or operation within such block diagrams, flowcharts, or examples can be implemented, individually or collectively, by a wide range of hardware, software, firmware, or virtually any combination thereof. Portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more processing devices (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually or collectively, by a wide range of hardware, software, firmware, or any combination thereof can be viewed as being composed of various types of circuitry.

What is claimed is:

1. A method for monitoring and delivering licensed content comprising:
displaying an interactive guided process comprising at least one augmented reality (AR) layer through an AR device;
detecting user interactions during the interactive guided process in the at least one AR layer as a content request and storing the user interactions in a user interaction log through operation of an AR controller;
validating the content request through operation of a content license authenticator; and
on condition a user has a valid license to requested content, releasing the requested content to the AR device; and
on condition the user does not have a valid license to the requested content, notifying the user of the lack of the valid license for the requested content and not releasing the requested content to the AR device;
displaying the requested content through the at least one AR layer;
recording user content interactions with the requested content in a content interaction log comprising previous user content interactions with previous requested content;
normalizing the user content interactions to the previous user content interactions and generating user engagement metrics for the requested content through operation of an analytics engine; and
communicating the user engagement metrics and previous user interactions to a content management engine.

2. The method of claim 1, wherein the requested content comprises procedural content that requires user interaction through a procedural interactive guided process.

3. The method of claim 2, wherein displaying the requested content through the at least one AR layer further comprises running the procedural content that requires user interaction through the procedural interactive guided process; and
detecting the user interactions further comprises detecting the user content interactions during execution of a closed-loop process during the running of the procedural content that requires user interaction through the procedural interactive guided process.

4. The method of claim 1, wherein recording the user content interactions further comprises:
detecting user physical indicators;
correlating the user physical indicators with the requested content as the user content interactions; and
recording duration of the user content interactions with the requested content.

5. The method of claim 4, further comprising analyzing the user content interactions to determine a need for support content.

6. The method of claim 1 further comprising:
communicating a content license control to the content license authenticator, in response to comparison of the user engagement metrics to a content engagement threshold.

7. The method of claim 1 further comprising:
communicating at least one of the user engagement metrics, the previous user content interactions and the previous user interactions to at least one or more of information managers, content creators, and content owners, wherein the information managers comprise entities managing a body of content, the content creators comprise entities generating content, and the content owners comprise entities licensing content.

8. A non-transitory computer-readable storage medium for monitoring and delivering licensed content, the non-transitory computer-readable storage medium including instructions that when executed by a computer, cause the computer to:
display an interactive guided process comprising at least one augmented reality (AR) layer through an AR device;
detect user interactions during the interactive guided process in the at least one AR layer as a content request and store the user interactions in a user interaction log through operation of an AR controller;
validate the content request through operation of a content license authenticator; and
on condition a user has a valid license to requested content, release the requested content to the AR device; and
on condition the user does not have a valid license to the requested content, notify the user of the lack of the valid license for the requested content and not release the requested content to the AR device;
display the requested content through the at least one AR layer;
record user content interactions with the requested content in a content interaction log comprising previous user content interactions with previous requested content;
normalize the user content interactions to the previous user content interactions and generate user engagement metrics for the requested content through operation of an analytics engine; and
communicate the user engagement metrics and previous user interactions to a content management engine.

9. The non-transitory computer-readable storage medium of claim 8, wherein the instructions further configure the computer to:
detect the user interactions during execution of a closed-loop process during the interactive guided process.

10. The non-transitory computer-readable storage medium of claim 8, wherein the instructions further configure the computer to:
detect user physical indicators;
correlate the user physical indicators with the requested content as the user content interactions; and
record duration of the user content interactions with the requested content.

11. The non-transitory computer-readable storage medium of claim 10, wherein the instructions further configure the computer to analyze the user content interactions to determine a need for support content.

12. The non-transitory computer-readable storage medium of claim 8 wherein the instructions further configure the computer to:
communicate a content license control to the content license authenticator, in response to comparison of the user engagement metrics to a content engagement threshold.

13. The non-transitory computer-readable storage medium of claim 8 wherein the instructions further configure the computer to:
communicate at least one of the user engagement metrics, the previous user content interactions and the previous user interactions to at least one of information managers, content creators, and content owners, wherein the information managers comprise entities managing a body of content, the content creators comprise entities generating content, and the content owners comprise entities licensing content.

14. The non-transitory computer-readable storage medium of claim 8, wherein the requested content comprises procedural content that requires user interaction through a procedural interactive guided process;
display the requested content through the at least one AR layer further comprises running the procedural content that requires user interaction through the procedural interactive guided process; and
detect the user interactions further comprises detecting the user content interactions during execution of a closed-loop process during the running of the procedural content that requires user interaction through the procedural interactive guided process.

15. A computing apparatus for monitoring and delivering licensed content, the computing apparatus comprising:
a processor; and
a memory storing instructions that, when executed by the processor, configure the apparatus to:
display an interactive guided process comprising at least one augmented reality (AR) layer through an AR device;
detect user interactions during the interactive guided process in the at least one AR layer as a content request and store the user interactions in a user interaction log through operation of an AR controller;
validate the content request through operation of a content license authenticator; and
on condition a user has a valid license to requested content, release the requested content to the AR device; and
on condition the user does not have a valid license to the requested content, notify the user of the lack of the valid license for the requested content and not release the requested content to the AR device;
display the requested content through the at least one AR layer;
record user content interactions with the requested content in a content interaction log comprising previous user content interactions with previous requested content;
normalize the user content interactions to the previous user content interactions and generate user engagement metrics for the requested content through operation of an analytics engine; and
communicate the user engagement metrics and previous user interactions to a content management engine.

16. The computing apparatus of claim 15, wherein the instructions further configure the apparatus to:
detect the user interactions during execution of a closed-loop process during the interactive guided process.

17. The computing apparatus of claim 15, wherein the instructions further configure the apparatus to:
detect user physical indicators;
correlate the user physical indicators with the requested content as the user content interactions; and
record duration of the user content interactions with the requested content.

18. The computing apparatus of claim 15 wherein the instructions further configure the apparatus to:
communicate a content license control to the content license authenticator, in response to comparison of the user engagement metrics to a content engagement threshold.

19. The computing apparatus of claim 15 wherein the instructions further configure the apparatus to:
communicate at least one of the user engagement metrics, the previous user content interactions and the previous user interactions to at least one of information managers, content creators, and content owners, wherein the information managers comprise entities managing a body of content, the content creators comprise entities generating content, and the content owners comprise entities licensing content.

20. The computing apparatus of claim 15, wherein the requested content comprises procedural content that requires user interaction through a procedural interactive guided process;
display the requested content through the at least one AR layer further comprises running the procedural content that requires user interaction through the procedural interactive guided process; and
detect the user interactions further comprises detecting the user content interactions during execution of a closed-loop process during the running of the procedural content that requires user interaction through the procedural interactive guided process.
